(19) United States
(12) Patent Application Publication
(10) Pub. No.: US 2013/0273832 A1
(43) Pub. Date: Oct. 17, 2013

(54) Portable Automobile Stereo and Radio Recorder

(71) Applicant: Sarah Coleman, Crewe, VA (US)

(72) Inventor: Sarah Coleman, Crewe, VA (US)

(21) Appl. No.: 13/860,598

(22) Filed: Apr. 11, 2013

Related U.S. Application Data
(60) Provisional application No. 61/623,954, filed on Apr. 13, 2012.

(51) Int. Cl. G11B 31/00

(52) U.S. Cl. CPC G11B 31/003
USPC 455/3.02; 369/7

(57) ABSTRACT

A portable audio recording device is provided for selectively recording analog and digital audio signals. The device is removably insertable into a recess in an automobile dashboard. Several mounting harness connections protrude from the recess and operatively engage with ports disposed on the back side of the device. Once the recording device is properly connected, audio can be played over the automobile sound system or saved for later playback. Additional files are transferred to and from the device via removable storage media or over wireless connections. Users can record radio programming, store their music collection and transport the entertainment device to different locations. The invention is thus a device and system for facilitating highly transportable audio recording, storage, and playback in a variety of environments.

### CROSS REFERENCE TO RELATED APPLICATION

This application claims the benefit of U.S. Provisional Application No. 61/623,954 filed on Apr. 13, 2012, entitled “Radio Car Recorder.”The patent application identified above is incorporated here by reference in its entirety to provide continuity of disclosure.

### BACKGROUND OF THE INVENTION

1. Field of the Invention

The present invention relates to a portable car audio recording system. Specifically, it relates to a car audio console that can be inserted into a recess port in an automobile dashboard. The system records radio broadcasts and can burn them to a compact disc or other removable media. Recorded radio segments are stored song files can be replayed at any time. When the user exits the automobile, the system can be ejected and carried indoors for further use.

The first audio systems installed in automobiles were am/fm radio consoles. These radio consoles included radio signal receivers connected to one or more speakers inset into the car dashboard. Dials were provided for tuning the radio station, controlling the volume and turning the radio on or off. Later additions to the radio console included eight track cassette player, cassette tape players, and compact disc players. Removable media players such as these provided automotive travelers with the ability to play specific audio tracks on command.

Current automotive audio systems offer a variety of listening options. Indeed, some systems even offer video playback of television and digital video discs (DVDs). Satellite radio receivers, TV tuners, mp3 playbacks and the like are common features of modern automotive entertainment systems. Passengers may listen to preprogrammed radio, provide their own playlists, or download new music and video tot eh console.

The problem with automotive entertainment systems is that they are generally integrated into the vehicle dashboard. Users are forced to create redundant copies of their music collection by transferring copies of songs from in home audio systems to the car systems. Alternatively, the user must bring a removable media or mp3 player to the vehicle and mount it within the onboard computer. A portable audio system is needed that is easy to transport from the car to the home and vice versa.

2. Description of the Prior Art

The present invention is a portable stereo system that can be removably integrated into an automobile audio system. A console is provided that can be connected to the automobile audio system via a series of jacks and plugs. Audio signals such as radio and satellite audio can be recorded to an electronic media within the stereo system. These audio files can then be transferred to computing devices via blue tooth, Wi-Fi, or through removable media. In this manner the present invention is both a device and a system for versatile audio recording and playback. The following devices and systems are considered to be a list of prior art relevant to the present disclosure

A system and method for pausing and continuing live radio input to an automobile stereo is described in Goodman, et al, U.S. Pat. No. 6,665,234. The system includes a radio antenna linked to a controller, an electronic media, and an audio output means. Audio signals are received by the antenna in the form of radio transmissions and are then sent to the controller for processing. A record button is electrically connected to the system and when engaged, disrupts the output of audio while recording commences. The signals are stored on the electronic media. Recording can be truncated at any time and normal radio signal playback resumed from the point at which the signal was last interrupted.

Goodman, U.S. Pat. No. 7,027,602 discloses a method for recording of audio signals onto an electronic media. The electronic media is stored within an automobile dashboard. When the system starts up, information about the automobile's subscription to a music service is sent to a remote data server. Once the subscription is confirmed audio signals may be received and processed by a controller within the stereo. The digital signals may be paused and resumed as desired, via the use of an electronic media to buffer the signals.

A similar system is disclosed in Logan, U.S. Pat. No. 7,058,376. The Logan system uses a time shifting method to record multiple audio signals to an electronic media. User interface buttons selectively perform the following five functions not available on a conventional radio: Pause: suspends the reproduction of the live or recorded programming currently being played; Save: permits the listener to save the complete content of a live program currently being reproduced; Jukebox: permits the listener can select and playback previously recorded programming; Mark: allows the user to “bookmark” a specific position on a program; and Options: permits the user to obtain information about available programming, or to perform less frequently used functions.

Recording of radio, television and satellite signals by an automobile console is described in Igbinadolor, U.S. Pat. No. 6,779,196. The system receives and processes incoming signals, monitoring their content. Selected audio signals are recorded on an electronic media for playback to a user. When a commercial break is detected the system automatically pauses the recording process. In this way, users are provided with a seamless audio playback that is free from commercial interruptions.

Finally, Owens, U.S. Pat. No. 6,067,278, disclosed a digital recorder for car radio. The system includes a car radio console and media player. A microphone is operatively connected to the front of the console unit so that sounds within the car can be recorded. Audio signals from the radio can also be recorded to and electronic media for later playback. The system thus provides automotive travelers with a means for recording music, discussions, and any important information they need to convey while driving.

These prior art devices have several known drawbacks. None of these devices provide a digital car radio recorder that includes wireless communication capabilities and is removable from the dashboard for use in other locations. The present invention is a highly portable stereo system that offers digital radio recording, wireless file transfer for transmission of MP3 files, and transfer or recorded or transmitted audio files to a removable media. It substantially diverges in design elements from the prior art and consequently it is clear that there is a need in the art for an improvement to existing devices. In this regard the instant invention substantially fulfills these needs.

### SUMMARY OF THE INVENTION

In view of the foregoing disadvantages inherent in the known types of automobile audio recording devices now present in the prior art, the present invention provides a new portable audio record system wherein the same can be utilized for providing convenience for the user when recording and playing audio feedback in any automobile or in the home.

The present invention is a combination automobile receiver console and recording device. There are two primary embodiments of the device. The first is a stock model that sits within a preformed recess in an automobile dashboard. The second embodiment is and an aftermarket model that removably connects to a series of ports installed on the top of the automobile dashboard. Both versions of the device have a set of connection jacks that operatively connect with ports in the automobile dashboard.

The device is removably secured to an automobile dashboard. One or more latches set into the dashboard engage with mating parts on the device, thereby holding it in place within or on top of the dashboard. The engaged position holds the portable audio recording device in operative and electrical connection with the automobile stereo system. An eject button disposed on the device or the automobile dashboard releases the latch engagement, permitting removal of the device from the dashboard. In this way, the device can be removed from one vehicle and inserted into the recess in another vehicle, providing users with a portable music playback device.

Whether installed in an automobile or used inside a dwelling, the portable audio recording device selectively stores audio signal streams. Audio signals such as radio or satellite signals are received by an antenna and sent to a controller. The signals are then converted from analog signals to digital and are saved to a storage medium. Users can trigger signal conversion and storage by interacting with a recording selection means such as a physical button, touch screen interface or the like. Audio retained on storage medium can be transferred to compact discs, flash drives, or other removable storage media. Users can thus record segments of audio signals and save them removable media that can be played in other devices.

It is therefore an object of the present invention to provide a new and improved portable audio recording device that has all of the advantages of the prior art and none of the disadvantages.

It is another object of the present invention to provide a means for recording segments of radio programming and saving those segments for later playback.

Another object of the present invention is to provide an audio receiver than can be conveniently removed from one automobile and inserted into another.

Yet another object of the present invention is to provide an audio recording and playback console for an automobile that can be removed from its position within the automobile dashboard and used inside a dwelling.

Still another object of the present invention is to provide a portable audio recorder that converts analog audio signals to digital signals for recording purposes.

A further object of the present invention is to provide a device that can be pre-installed in an automobile dashboard or attached to an adapted dashboard.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the front face of the portable audio recording device.

FIG. 2 shows a perspective view of the rear of the portable audio recording device.

FIG. 3 shows a general schematic of the internal components of the portable audio recording device.

FIG. 4 shows a general system diagram of the portable audio recording system of the present invention.

FIG. 5 shows a perspective view of the portable audio recording device in use. The device is inserted into a preformed recess in an automobile dashboard.

FIG. 6 shows a perspective view of the portable audio recording device in use. The device is lowered onto a small recess and set of ports formed on the top surface of an automobile dashboard.

### DETAILED DESCRIPTION OF THE INVENTION

Reference is made herein to the attached drawings. Like reference numerals are used throughout the drawings to depict like or similar elements of the portable audio recording device and system. For the purposes of presenting a brief and clear description of the present invention, the preferred embodiment will be discussed as used for recording analog or digital audio while on-the-go. The figures are intended for representative purposes only and should not be considered to be limiting in any respect.

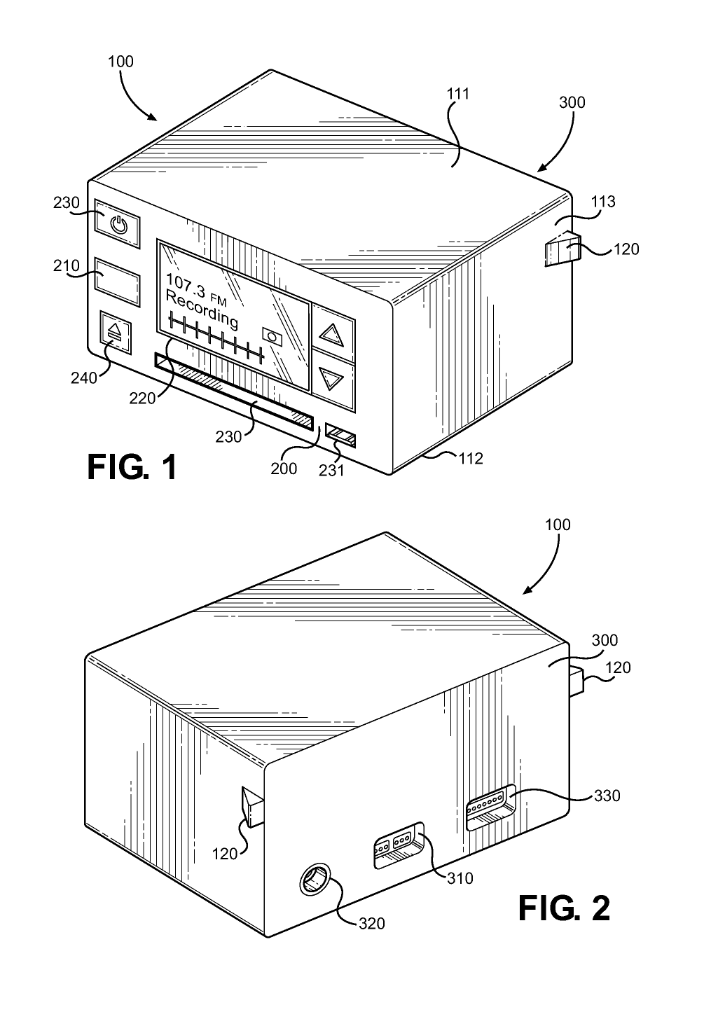

Referring now to FIG. 1, there is shown an exemplary portable audio recording device. The device 100 comprises an outer housing 110 with a top 111, bottom 112, two lateral sides 113, a front face 200 and rear face 300 defining an interior volume. Construction of the outer housing should render a product suitable for use on desktops, automobile dashboards and other all purpose surfaces. Sharp metal edges and aluminum casings are not desirable as they may injury users during transport or scuff supporting surfaces. Plastics, polished metal and other such materials are ideal for construction of the housing as they are often used in the construction of home stereo components. Thus it is wholly desirable that the device have the outward appearance and the utility of an automobile audio receiver and media player, as well as an in home radio and media playback console.

Securing latches 120 prevent the audio recording device from uncoupling from the automobile dashboard while in use. The latches are depressible and engage with latch receiving recesses inside the automobile dashboard recess. In the figure these latches are shown as triangular protrusions that can be pressed into the lateral sides of the outer housing, when the device is slid into the automobile dashboard recess. Once the device is in place, the latches expand into the latch receiving recesses. Other latching mechanisms are well known in the art and may be substituted for that shown here. Release of the latches is affected by depressing a release button 210 which is operatively connected to the latches and retracts them into the housing. While the release button is depressed the device can be safely removed from the automobile dashboard recess. In alternative embodiments, the release button may be disposed on the dashboard rather than the console and may affect depression of the latches into the housing by pushing them out of the latch receiving recesses with pistons or the like.

The front face of the portable audio recording device has several user input options that facilitate operation of the device. On the front face 200, there is a display screen 220, removable storage media insertion slots 230, 231, a disc ejection button 240, a device release button 210, and a power button 250. Though any digital display may be used, a touch screen interface is desired, to limit the need for additional physical controls. By way of example, if a standard LCD display is used, tuning buttons, a record button, and seek/scan buttons must also be disposed on the front face and operatively connected to the device's internal components. Conversely, a touch-screen display, as shown in the figure, displays current audio playback information to a user, and also facilitates recording, station changing, volume control, and other standard media player functions.

Removable storage media interfaces 230, 231 provide users with an easy means for transferring audio files to and from the audio recording device. Rewritable compact discs are inserted into the device via the compact disc drive slot 240. A flash drive 231 is operatively connected to the device via a universal serial bus (USB) port disposed on the front face. Audio files stored on these media can be transferred to the device's permanent storage and accessed for playback via the touch-screen interface. Alternatively, audio recorded by the device and stored on the permanent storage medium can be transferred to the removable media for playback on another device. After transfer or playback, compact discs are ejected from the disc drive via a CD eject button 240 located near the disc slot or integrated into the touch screen interface. The portable audio recording device is also Wi-Fi and Bluetooth enabled to allow computing devices such as laptops, and smart phones to transfer music to and from the device.

An essential component of the device is the audio record input option. In a preferred embodiment this option is integrated into the touch-screen interface, but it may also be a physical button disposed on the front face 200. Users interact with the audio record input to start and stop analog and digital audio recording. Audio signals from radio and satellite sources can be converted to digital audio files as necessary and stored on the permanent storage media for later playback. Additionally, the user also has the option of utilizing an audio identification function that will record a small segment of an audio signal and compare the segment with a remote music ID service that will find the song and offer it to the user for download to the portable audio recording device.

A view of the rear face 300 is shown in FIG. 2 of the drawings. Along the rear face is a set of harness mounting points. A power mounting harness port 330 is provided for electrically connecting the device to a power harness disposed within the automobile dashboard recess. Power harness may have wiring for both switched and constant power or may be simply directed current. This connection facilitates the flow of electricity from the automobile battery to the audio recording device. An auxiliary mounting harness port 310 engages with an auxiliary mounting harness disposed within the back of the automobile dashboard recess. Wiring running to the auxiliary mounting harness includes but is not limited to left and right front speakers, left and right rear speakers, a chassis ground, and illumination wiring. Lastly, an antenna connection port 320 is provided, that engages with an antenna harness and operatively connects the device to the automobile's antenna. The aforementioned mounting harnesses are fixed in place along the rear surface automobile dashboard recess and align with the mounting points of the recording device. In this way, the device is inserted into the dashboard recess and easily connected to the necessary harnesses. Users do not need to meddle with connections, crimping of wires, or even interact with the wiring components in order to use the present invention. Latches 120 disposed on laterally opposing sidewalls of the device housing prevent the device from shifting during use and thereby reduce strain on the harness connections.

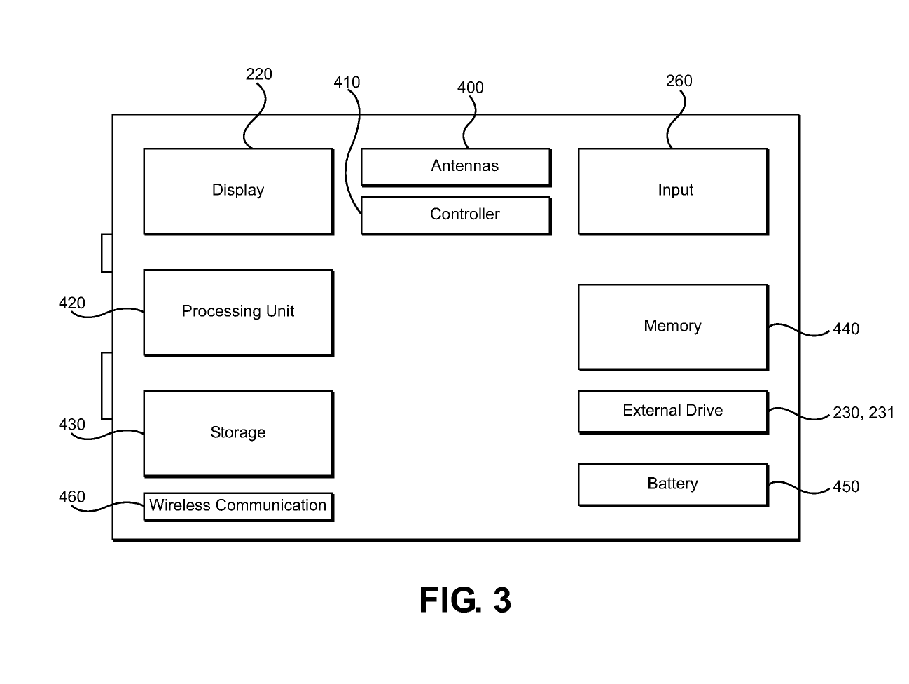

Essential internal components of the device are shown in the side view of FIG. 3. Antennas 400 detect audio signals and digital data signals. These antennas are connected to a controller 410 which can send the signals to the automobile, or in home speakers, or alternatively send the signals to the digital processing unit 420. If conversion from analog to digital signal is necessary the digital processing unit will load segments of the signals into memory 440 and utilize a stored programmable logic to convert the signals. Both detected and converted digital audio signals are stored on the permanent storage media 430 for later playback or transfer. Transfer to one or more types of removable storage media is possible when the media is mounted within a removable media slot 230, 231 such as the compact disc drive or USB port. Users can begin and end recording and select audio files for transfer via the input means 260 and display 220, which are preferably integrated together into a touch screen display unit. External wireless connections are also made via the antennas or other wireless communications means, for transferring audio files, identifying audio segments, or downloading new audio files. These component parts are stored within the interior volume of the audio recording device housing.

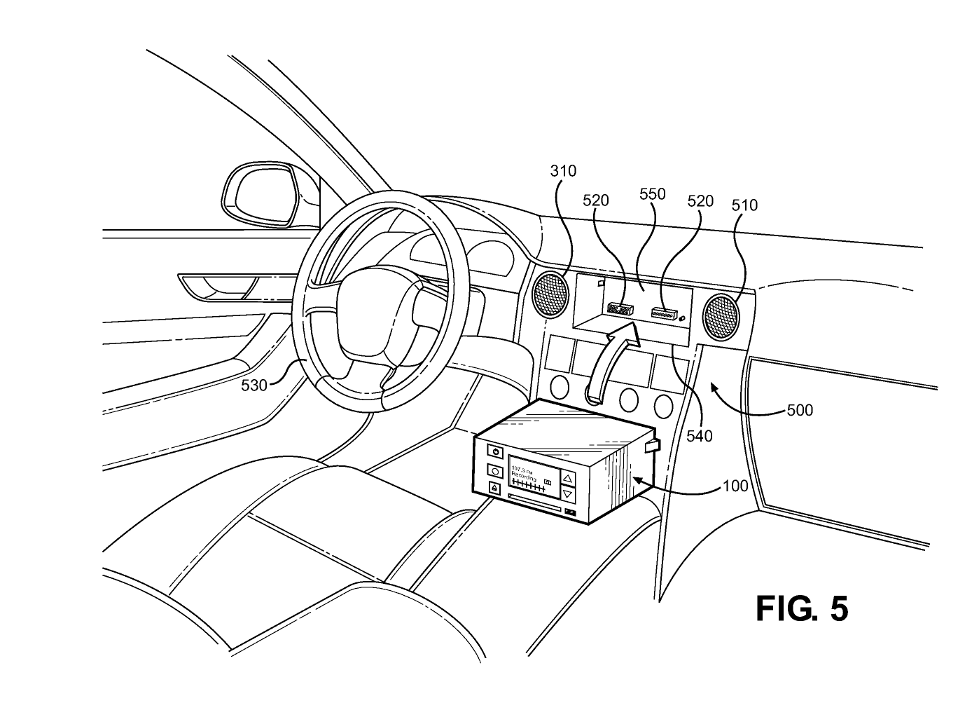

Referring now to FIG. 5, there is shown a perspective view of the portable audio recording device being inserted into an automobile. The device 100 is inserted into a preformed automobile dashboard recess 540. This recess may be located anywhere on the dashboard console 500 but should be disposed within easy reaching distance of drivers and passengers. In the figure, the recess is located between the left and right front speakers 510, and to the right of the steering wheel 530. Mounting harnesses 520 disposed along the back of the recess engage with harness ports in on the rear face of the audio recording device. Latch receiving recesses 550 hold the device housing in place while it is inserted within the dashboard recess. In this embodiment the dashboard recess is preformed as a part of the dashboard console and has permanently fixed mounting harnesses that engage and disengage with the recording device.

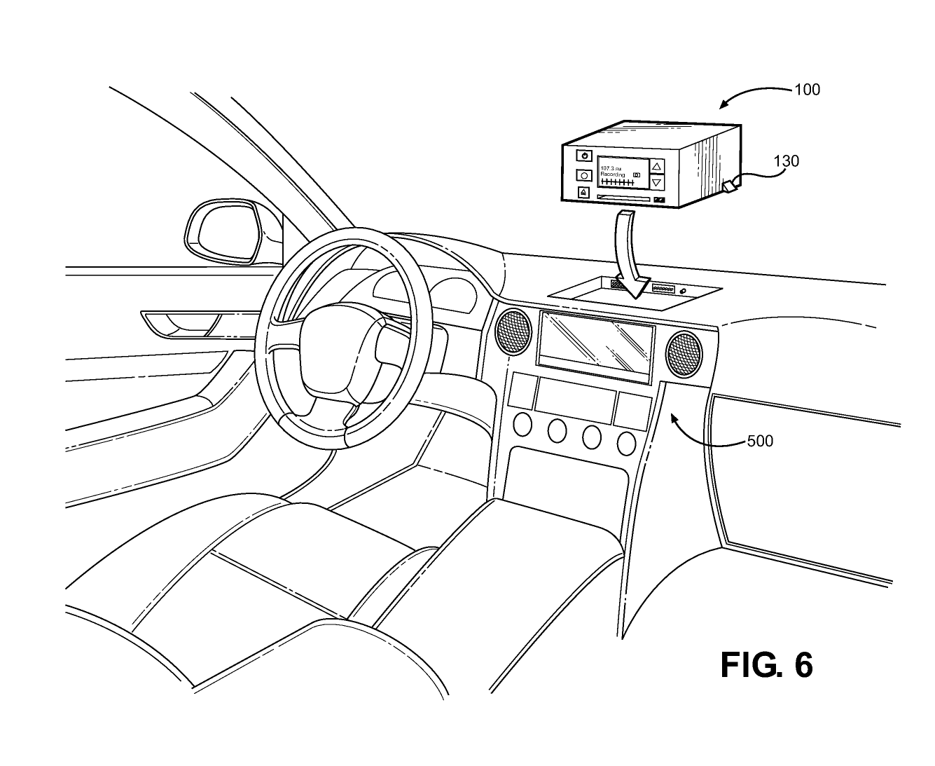

Turning now to FIG. 6 there is shown an alternative embodiment of the portable audio recording device. In this embodiment the device is part of an aftermarket portable audio recording system. A piece of the dashboard 500 upper surface is removed and a dashboard recess 540 is inserted. Mounting harnesses 520 extend through a lip at the rear of the recess, protruding through the upper surface of the dash. Caps may be applied to these harnesses when not in use to prevent dust and debris from entering. The audio recording device has mounting harness ports disposed along the rear face though they may need to be placed lower on the face than in the primary embodiment depending on the desired size of the dashboard recess. Latches 130 may be disposed along the bottom or lower edge of the lateral sidewalls for engaging with latch receiving recesses 550 within the dashboard recess. Like the primary embodiment, the recording device housing in held in place by the latches during periods of use to prevent strain on the harness connections. The device can be easily disengaged and carried indoors for continued use after the automobile is turned off. This embodiment of the device provides users with the ability to take advantage of the versatile audio recording device without requiring the installation of whole new dashboard console unit.

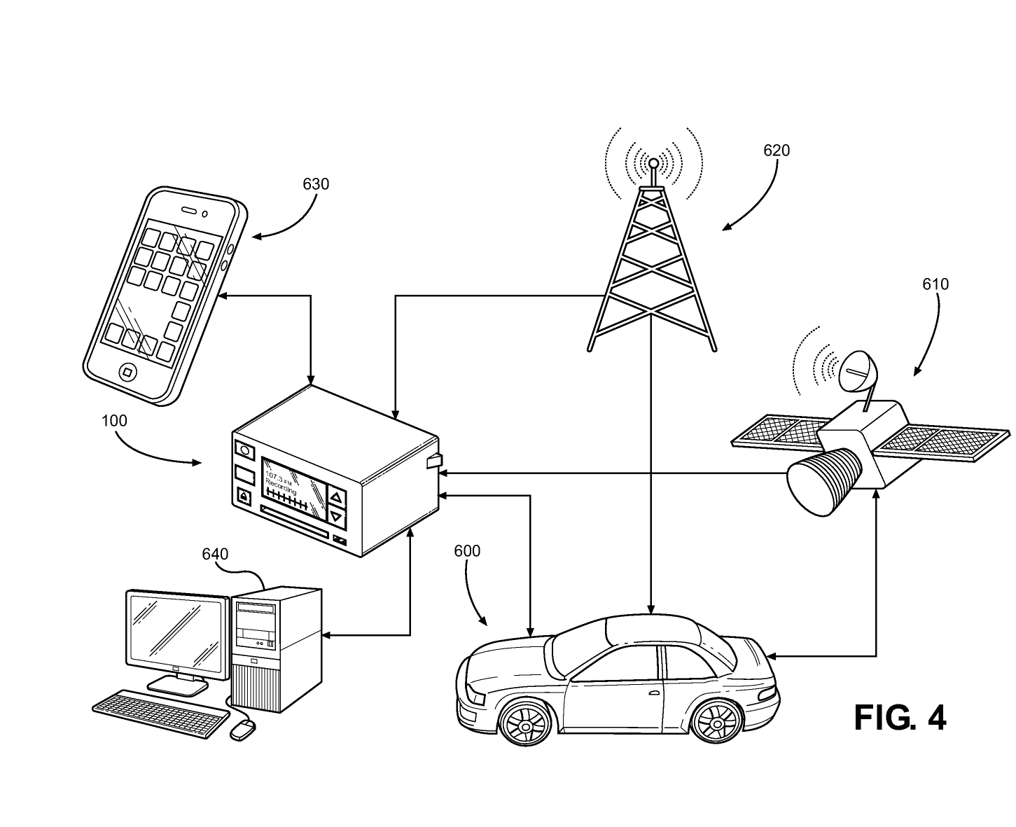

Referring finally to FIG. 4, there is shown a general view of an exemplary embodiment of the present system. It includes a portable audio recording system 100 capable of functioning will connected to an automobile 600 sound system or to an in home sound system. Antennas within the device perceive audio and data signals from radio emitters 620 and satellite transmitters 610, as well as computing devices 630 having Wi-Fi or Bluetooth capabilities. Received audio files are stored on a storage media within the audio recording device. Audio files stored on the computing device can be transferred to the audio recording device storage media via a short range wireless connection. Audio files can also be downloaded for external file download services hosted on remote servers 640.

In use an individual turns the portable audio recording device on by initiating the power button. A preferred radio station or program is then selected via the user interface. The user then presses the record button to begin recording of the current audio programming. Engaging the record button again stops the recording process. Next the user can select the recently recorded audio program and any other audio files for transfer to a removable storage media. A removable storage media such as a compact disc or flash drive is inserted into an appropriate slot on the front face of the audio recording device. Files are then transferred to the removable media, which can be removed and inserted into other devices for playback. Audio files stored on the permanent storage media can be selected for playback on the automobile recording device. When the user turns the car off, he depresses the eject button to eject the recording device from the dashboard. The recording device is then carried inside and connected to a dc power adapter. An indoor speaker adapter is plugged into the auxiliary mounting harness port and then connected to a pair of indoor speakers. The user can then listen to the recorded audio or any other stored audio files within the comfort of his home.

The present invention provides a new portable audio recording device that can be used in an automobile or in-home environment. The outer housing of the device fits within and engages a recess built into an automobile dashboard, and is thereby electrically connected to the automobile battery and audio system. Radio program can be recorded, sent to a remote service for identification, and used to initiate audio file downloads to the storage media. Recorded and downloaded files can be played on the automobile's speaker system or transferred to a removable storage media for playback on other devices.

A dc power adapter that plugs into the mounting harness port on the rear face of the recording device and into a wall socket. Similarly an auxiliary speaker adapter is included that connects to the auxiliary mounting port on the rear face of the device and also includes ports for positive and negative speaker terminals. In this way, the device is easily adapted for in home use. Both of these adapted may be simple geometrically shaped elements having the aforementioned ports.

The versatile nature of the present invention makes it useful in different environments. Users can transfer their music collection from one automobile to another, so long as both automobiles have the appropriate dashboard recess and connection harnesses. Similarly, the present invention obviates the need for having in home and car audio receivers, because the same receiver unit can be used in both places. Each user can transfer their personal music collection to the device via removable storage media, a Bluetooth or Wi-Fi connection.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable audio recording device comprising:
an outer housing having a front face, a rear face, a top wall, a bottom wall, and two side walls defining an interior volume;
internal components comprising a storage medium, a processing unit, a memory, a controller, one or more antennas, a disc drive, a wireless communication means, and a battery housed within said interior volume;
a machine-readable logic stored on said storage volume for converting analog signals detected by said one or more antennas into digital signals suitable for storage on said storage media;
a display disposed on said front face and operatively connected to said internal components;
at least one input means disposed on said front face and operatively connected to said internal components;
a plurality of removable storage media ports disposed on said front face and operatively connected to said internal components;
a power button disposed on said front face and operatively connected to said internal components;
a power mounting harness port disposed on said rear face and operatively connected to said internal components;
an auxiliary mounting harness port disposed on said rear face and operatively connected to said internal components;
an antenna harness port disposed on said rear face and operatively connected to said internal components;
a dashboard recess adapted to receive said outer housing and having automobile wiring comprising a power mounting harness, an auxiliary mounting harness, and an antenna harness protruding therefrom, and wherein said dashboard recess is installed in an automobile dashboard when in use;
a securing means disposed on laterally opposing sides of said outer housing, wherein said securing means engage with matching securing means disposed within said dashboard recess;
an eject button operatively connected capable of disengaging said securing means.

2) The device of claim 1, wherein said display and input means are integrated into a touch-screen display.

3) The device of claim 1, wherein one of said removable storage media ports is a compact disc receiving slot.

4) The device of claim 1, wherein one of said removable storage media ports is a universal serial bus port.

5) The device of claim 1, wherein said dashboard recess has two side walls, a top and bottom wall, a rear wall, and an open front.

6) The device of claim 1, wherein said dashboard recess has a bottom wall and four upstanding walls forming a lip around said bottom wall.

7) The device of claim 1, wherein said securing means are depressible latches and said mating securing means are corresponding notches.

8) The device of claim 1, wherein said eject button is disposed on said front face of said outer housing.

9) A system for recording audio in a variety of environments comprising:
a portable audio recording device as in claim 1;
a network;
a radio signal transmitter;
a satellite adapted to transmit audio or data signals;
wherein signals received by said portable audio recording device from said radio signal transmitter or said satellite may be selectively stored within said portable audio recording device;
an automobile adapted to operably and removably engage said portable audio recording device;
a portable computing device capable of wirelessly transferring audio files to and from said portable audio recording device via said network;
a remote server associated with an audio file repository, wherein audio files may be transferred from said server to said portable audio recording device via said network.
